(19) United States
(12) Patent Application Publication
(10) Pub. No.: US 2014/0110928 A1
(43) Pub. Date: Apr. 24, 2014

(54) MEDICAL INFORMATION BOOKLET

(71) Applicants: Michael Martin Tymes, Philadelphia, PA (US); Joann Denise Tymes, Philadelphia, PA (US)

(72) Inventors: Michael Martin Tymes, Philadelphia, PA (US); Joann Denise Tymes, Philadelphia, PA (US)

(21) Appl. No.: 14/059,101

(22) Filed: Oct. 21, 2013

Related U.S. Application Data
(60) Provisional application No. 61/716,290, filed on Oct. 19, 2012.

(51) Int. Cl. B42D 1/00

(52) U.S. Cl. CPC B42D 1/003
USPC 281/38

(57) ABSTRACT

A medical booklet that may be carried on a patient's person. The medical booklet may include information such as allergic reactions, medical conditions, medications, important medical information, current concerns, female history, surgeries, family history, vitamins, over the counter medications, mammograms, colonoscopies, pap tests, important contact information and the like.

### CROSS-REFERENCE TO RELATED APPLICATION

This application claims the benefit of priority of U.S. provisional application No. 61/716,290, filed Oct. 19, 2012 the contents of which are herein incorporated by reference.

### BACKGROUND OF THE INVENTION

The present invention relates to a medical information booklet and, more particularly, to a medical information booklet carried by the patient to provide to a doctor.

Currently, when visiting a doctor's office, the doctor may ask an assortment of questions involving your health, passed medical procedures, and medications that the patient may be allergic to. Sometimes, the patient may have a lot of information to disclose and may forget to disclose important information. Further, a patient may not be conscious and a medical procedure may have to be performed immediately. In such cases, medical procedures can be risky when the patient's medical information is not disclosed.

As can be seen, there is a need for a portable device that includes medical information.

### SUMMARY OF THE INVENTION

In one aspect of the present invention, an apparatus comprises: a portable information device comprising medical information of a user, wherein the medical information comprises at least an allergy tab comprising the user's allergies, a medical conditions tab comprising the user's medical conditions, a medications tab comprising the user's current medication, and an important medical information tab comprising at least one of information about the user's will, whether the user is an organ donor, whether the user has a medical power of attorney (POA), whether the user's medical POA is filed at a hospital, whether the user's family is aware of their medical wishes, the user's blood type, whether the user would like to go on life support, and if the user has an implant.

These and other features, aspects and advantages of the present invention will become better understood with reference to the following drawings, description and claims.

### BRIEF DESCRIPTION OF THE DRAWINGS

FIG. 1 is a front view of the present invention;

FIG. 2 is a page detail view of the present invention;

FIG. 3 is a page detail view of the present invention;

FIG. 4 is a page detail view of the present invention;

FIG. 5: is a page detail view of the present invention;

FIG. 6 is a page detail view of the present invention;

FIG. 7 is a page detail view of the present invention;

FIG. 8 is a page detail view of the present invention;

FIG. 9 is a page detail view of the present invention;

FIG. 10 is a page detail view of the present invention;

FIG. 11 is a page detail view of the present invention;

FIG. 12 is a page detail view of the present invention;

FIG. 13 is a page detail view of the present invention;

FIG. 14 is a page detail view of the present invention;

FIG. 15 is a page detail view of the present invention;

FIG. 16 is a page detail view of the present invention; and

FIG. 17 is a page detail view of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a medical booklet that may be carried on a patient's person. The medical booklet may include information such as allergic reactions, medical conditions, medications, important medical information, current concerns, female history, surgeries, family history, vitamins, over the counter medications, mammograms, colonoscopies, pap tests, important contact information and the like.

The present invention may include a source of medical information in one easy to read format that may answer medical questions quickly. The present invention may prevent costly and painful procedures and tests since the required information may at hand. The present invention may eliminate guess work because the booklet may keep current information and may allow users to quickly respond to medical questions at a glance. Further, if the patient is unconscious, the medical team may review the booklet and determine the necessary medical information of the patient.

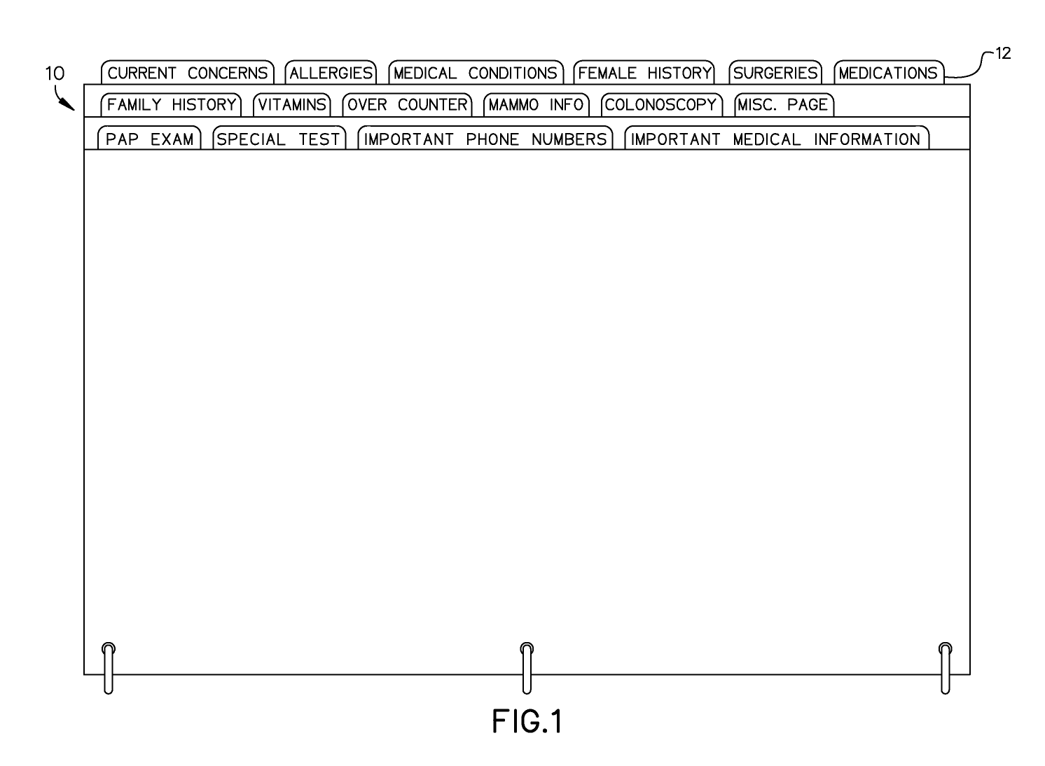

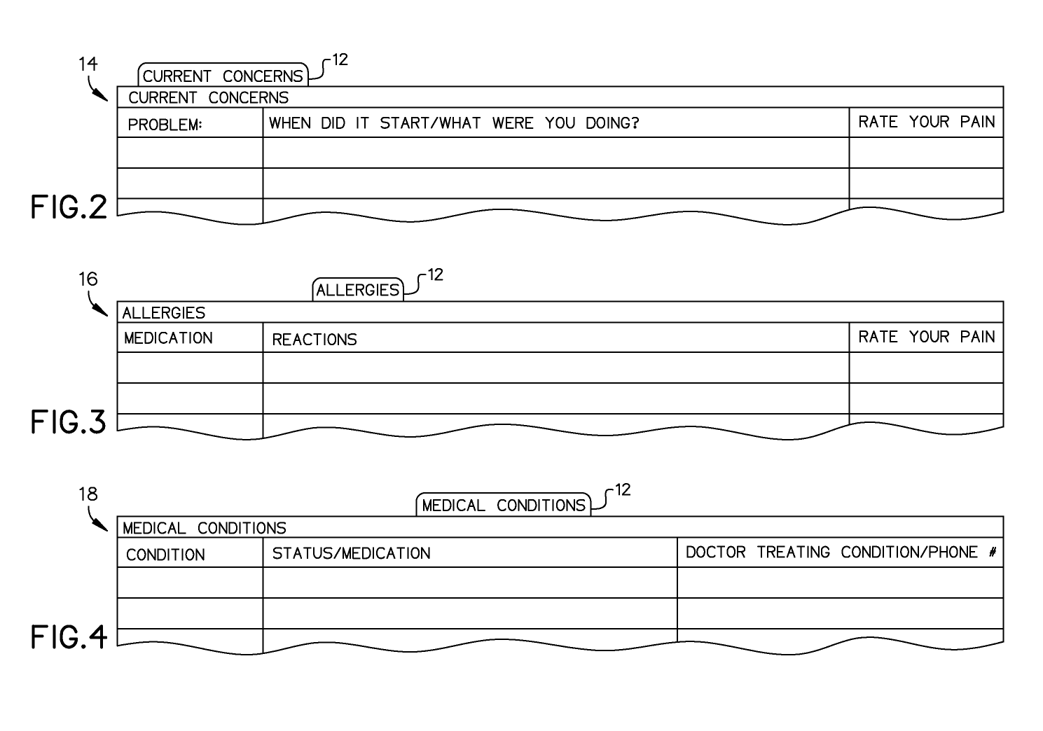

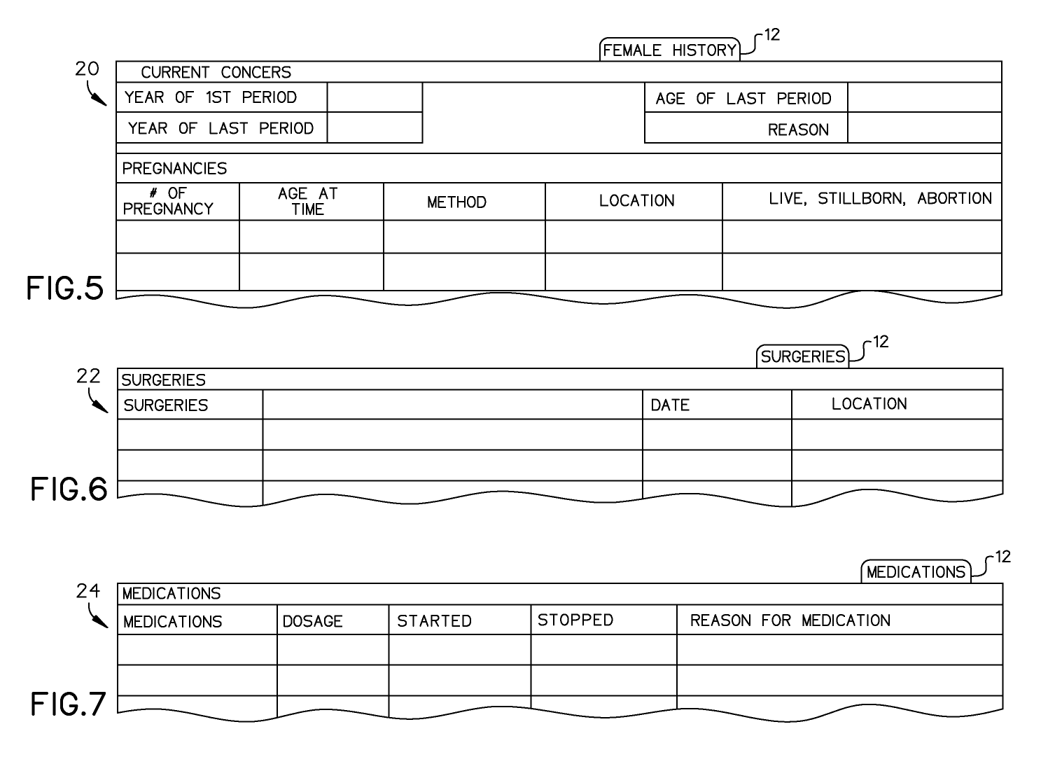

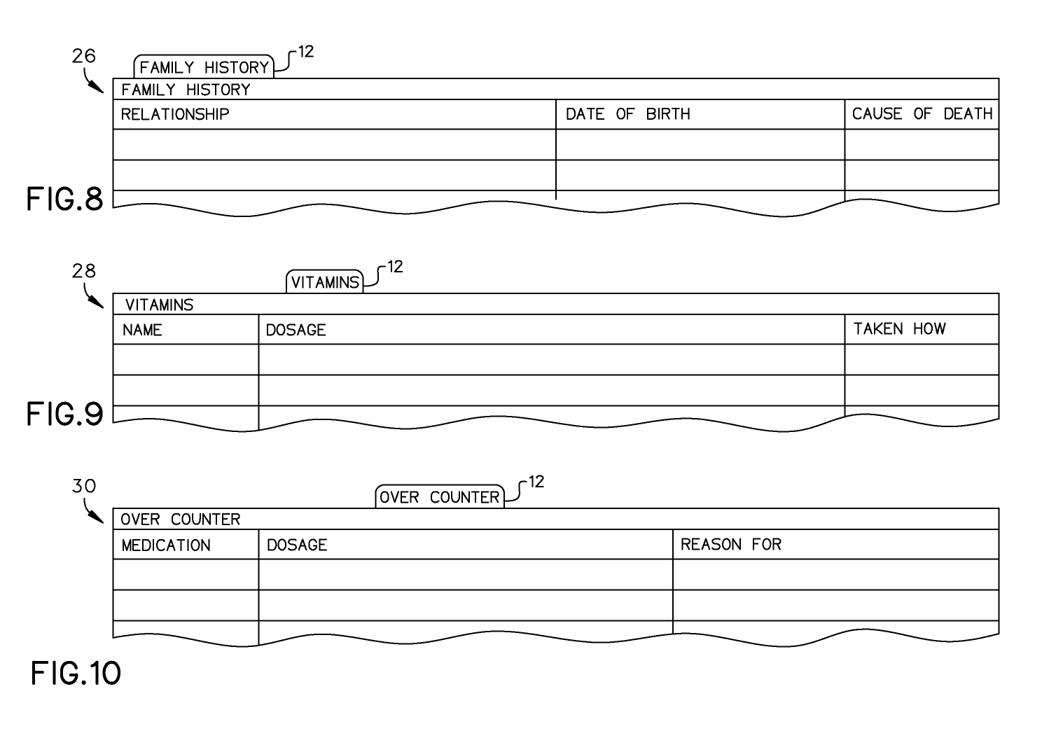

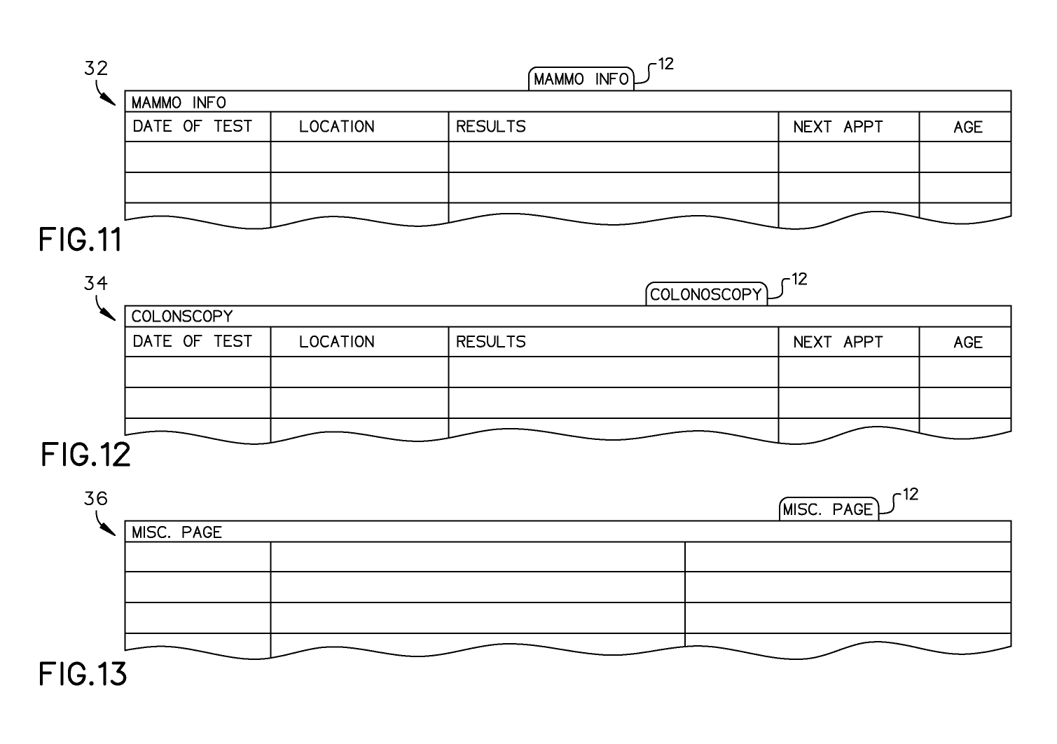

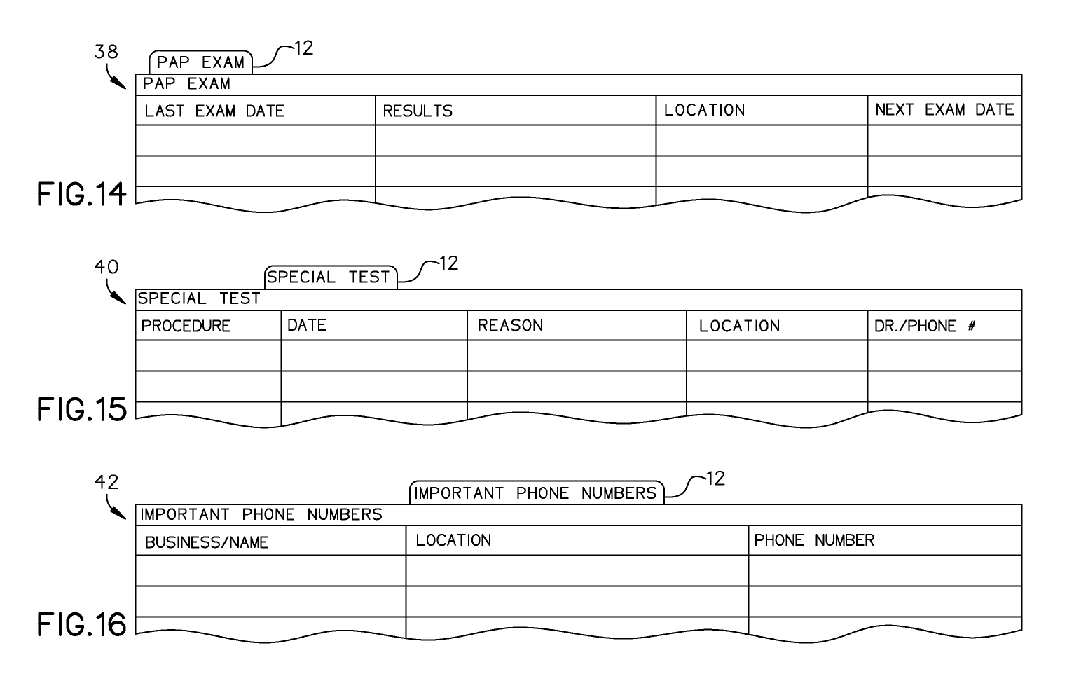

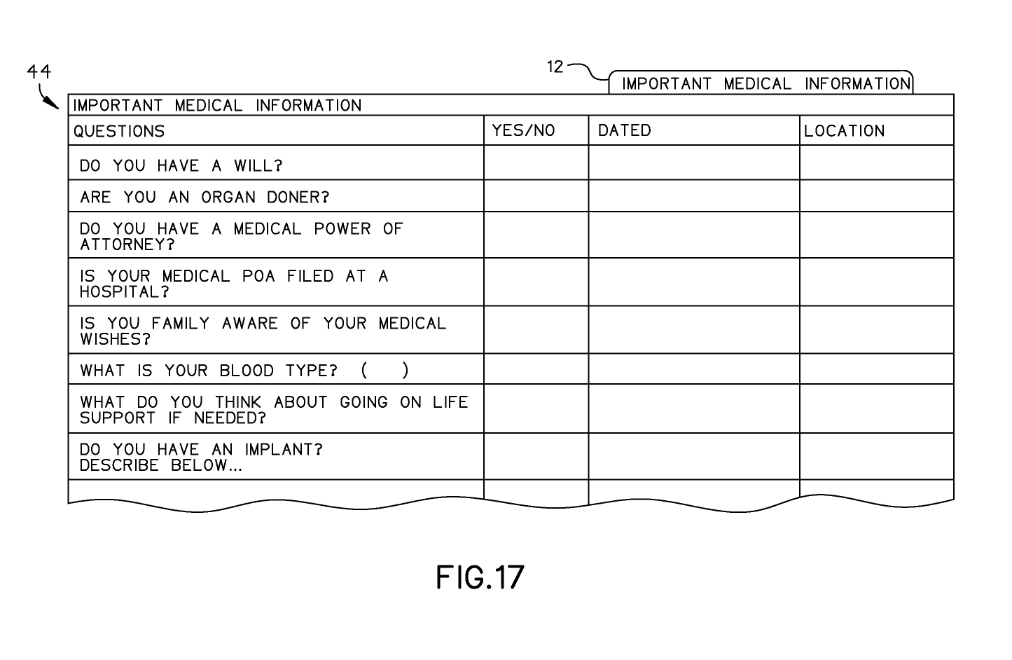

Referring to FIGS. 1 through 17, the present invention may include a portable information device 10. The portable information device 10 may be a booklet, or notepad that may be easily carried around in a pocket or in a purse. However, the present invention is not limited to a booklet or notepad and may be an electronic device. The portable information device 10 may include pertinent medical information needed for a doctor to provide treatment. In certain embodiments, the present invention may include a plurality of tabs 12 so that a user may quickly ascertain information needed. The tabs may include at least an allergy tab 16, a medical conditions tab 18, a medications tab 24, and important medical information tab 44.

As mentioned above, the present invention may include an allergies tab 16. The allergies tab 16 may include the type of medication and the type of reaction the user gets when taking the medication. In certain embodiments, the allergies tab 16 may further include a rate your pain column in which a user may rate the extent of pain that is experienced from a one to ten scale.

The present invention may include a current concerns tab 14. The current concerns tab 14 may include the current problem, when the current problem began, and what the user was doing when the problem occurred. In certain embodiments, the current concerns tab 14 may further include a rate your pain column in which a user may rate the extent of pain that is experienced from a one to ten scale.

The present invention may include a medical conditions tab 18. The medical conditions tab 18 may include the medical conditions of the user, the status of the medical conditions, and the medication the user is taking to treat the medical condition. In certain embodiments, medical conditions tab 18 may further include the doctor's contact information that is currently treating the condition.

The present invention may include a female history tab 20. The female history tab 20 may include the year of the women's first and last period, the age of the last period, and pregnancy information such as the number of pregnancies, the age and time of delivery, the method of delivery, the location, and the outcome of the childbirth, i.e. stillborn, live or aborted.

The present invention may include a surgeries tab 22. The surgeries tab 22 may include the past surgeries that the user has undergone, the date of the surgery and the location of the surgery. In certain embodiments, the tab 22 may further include the information of the doctor who performed the surgery.

The present invention may include a medications tab 24. The medications tab 24 may include the medications the user is currently taking. The medications tab 24 may further include the dosage, when the user started and stopped, and the reason for the medication.

The present invention may further include a family history tab 26. The family history tab 26 may include a list of the family members and their relation to the user, the date of birth of the family member, and a cause of death (if applicable). The family history tab 26 may also include any disorders or diseases that the family member had, such as heart disease.

The present invention may further include a vitamins tab 28. The vitamins tab 28 may include any vitamins that the user is taking. The tab 28 may include the name of the vitamin, the dosage of the vitamin, and the method of taking the vitamin.

The present invention may further include an over the counter tab 30. The over the counter tab 30 may include information about the medication a user is taking over the counter. The tab 30 may include the name of the medication, the dosage, and the reason for taking the medication.

The present invention may further include a mammogram tab 32. The mammogram tab 32 may include information about the user's past mammograms. The mammogram tab 32 may include the date of the test, the location of the test, the results of the test, and the next appointment scheduled. The tab 32 may also include the age of the user when the mammogram was taken.

The present invention may further include a colonoscopy tab 34. The colonoscopy tab 34 may include information about the user's past colonoscopies. The colonoscopy tab 34 may include the date of the test, the location of the test, the results of the test, and the next appointment scheduled. The colonoscopy tab 34 may also include the age of the user when the colonoscopy was taken.

The present invention may further include a miscellaneous page tab 36, which may include any additional medical information not mentioned in other tabs.

The present invention may further include a PAP exam tab 38. The PAP exam tab 38 may include information about the user's past pap tests. The PAP exam tab 38 may include the date of the test, the location of the test, the results of the test, and the next appointment scheduled. The PAP exam tab 38 may also include the age of the user when the PAP was taken.

The present invention may further include a special tests tab 40. The special tests tab 40 may include tests that may not be covered in the other tabs. The special tests tab 40 may include the type of procedure, the date, the reason, the location and the doctor's information.

The present invention may further include an important phone numbers tab 42. The important phone numbers tab 42 may include the name or business name an emergency contact of the user, the location of the emergency contact, and the phone number of the emergency contact.

The present invention may further include an important medical information tab 44. The important medical information tab 44 may include a series of questions that are answered by the user. For example, the questions may include, but are not limited to, information about the user's will, whether the user is an organ donor, whether the user has a medical power of attorney (POA), whether the user's medical POA is filed at a hospital, whether the user's family is aware of their medical wishes, the user's blood type, whether the user would like to go on life support, and if the user has an implant. The important medical information tab 44 may further include the date in which the person has acknowledged the information and the location in which the user has acknowledged the information.

It should be understood, of course, that the foregoing relates to exemplary embodiments of the invention and that modifications may be made without departing from the spirit and scope of the invention as set forth in the following claims.

What is claimed is:

1. An apparatus comprising:
a portable information device comprising medical information of a user, wherein the medical information comprises at least an allergy tab comprising the user's allergies, a medical conditions tab comprising the user's medical conditions, a medications tab comprising the user's current medication, and an important medical information tab comprising at least one of information about the user's will, whether the user is an organ donor, whether the user has a medical power of attorney (POA), whether the user's medical POA is filed at a hospital, whether the user's family is aware of their medical wishes, the user's blood type, whether the user would like to go on life support, and if the user has an implant.

2. The apparatus of claim 1, wherein the portable information device is a notebook.

3. The apparatus of claim 1, further comprising a current concerns tab comprising information about the user's current medical issues.

4. The apparatus of claim 1, further comprising a female history tab comprising information about at least one of the menstrual cycle and past pregnancies.

5. The apparatus of claim 1, further comprising a surgeries tab comprising information of past surgeries the user has undergone.

6. The apparatus of claim 1, further comprising a family history tab comprising family medical information.

7. The apparatus of claim 1, further comprising a vitamins tab comprising a list of the vitamins the user is currently taking.

8. The apparatus of claim 1, further comprising an over the counter tab comprising a list of over the counter medication the user is taking.

9. The apparatus of claim 1, further comprising a mammogram tab comprising information about past mammograms of the user.

10. The apparatus of claim 1, further comprising a colonoscopy tab comprising information about past colonoscopies of the user.

11. The apparatus of claim 1, further comprising a miscellaneous page comprising any additional information about the user.

12. The apparatus of claim 1, further comprising a PAP exam tab comprising information about past PAP exams of the user.

13. The apparatus of claim 1, further comprising a special test tab comprising information about past tests and results of the tests.

14. The apparatus of claim 1, further comprising an important phone numbers tab comprising emergency contacts of the user.

15. A method of providing medical information to a doctor comprising:
providing the apparatus of claim 1;
carrying the portable information device; and
providing medical information to a doctor using the portable information device.
